(19) United States
(12) Patent Application Publication
(10) Pub. No.: US 2020/0347968 A1
(43) Pub. Date: Nov. 5, 2020

(54) SEAL AND CLAMPING DEVICE AND ASSEMBLY COMPRISING SUCH A SEAL

(71) Applicant: CAILLAU, Issy-Les-Moulineaux (FR)

(72) Inventors: DYLAN CLERC, ROMORANTIN-LANTHENAY (FR); ARNAUD JACQUELIN, MUR DE SOLOGNE (FR)

(21) Appl. No.: 16/861,313

(22) Filed: Apr. 29, 2020

(30) Foreign Application Priority Data
May 3, 2019 (FR) 19 04668

(51) Int. Cl. F16L 21/06; F16L 21/00

(52) U.S. Cl. CPC F16L 21/065; F16L 21/005

(57) ABSTRACT

The seal comprises first and a second coaxial sleeve disposed around each other while being retained relative to each other. Each sleeve is formed by a strip wound on itself whose ends are configured to cooperate together via a sealing arrangement by allowing a reduction in the diameter of the sleeve. The sealing arrangements of the two sleeves are angularly offset. The clamping device comprises a clamping collar with a belt inside which the seal is disposed while being retained axially relative to the collar.

### TECHNICAL FIELD

The present disclosure relates to a seal, as well as to a clamping device and a clamping assembly comprising such a seal.

### BACKGROUND

There are known ring-shaped seals made by a closed ring. In order to achieve their sealing function, these seals must be compressed and must therefore be formed in materials allowing such compression while having the qualities required to withstand the conditions of the environment in which the seal is placed, for example in terms of pressure, temperature, or variation of these parameters. In addition, generally, for such closed seals, the difference between the diameter of the seal in the free state and the diameter of the seal in the clamped state, after compression, is generally small. Thus, these closed-type seals are not suitable for some applications.

There are also known, for example from patents EP 2 598 785 and EP 3 232 107, clamping devices comprising a collar which has a belt able to be clamped by reduction of its diameter and a pre-mounted seal in the collar. More specifically, this system comprises a washer which comprises a closed annular portion forming the seal and lugs connecting this seal to the collar. The closed annular seal is initially maintained at a significant distance from the inner periphery of the collar so as to allow the engagement of the outer tube between the seal and this inner periphery. Then, the inner tube is in turn engaged so as to come into contact with the seal. This device is particularly adapted to clamp two tubes fitted together and having radially protruding flared surfaces serving as a bearing for a clamping collar which comprises a recess which can house these radially protruding flared surfaces, the closed annular seal having itself a frustoconical shape adapted to these flared surfaces.

There are also known open-type seals, particularly of the type made by a strip wound on itself and whose ends cooperate together via a sealing arrangement. Such a seal is for example disclosed in document EP 1 181 477. A seal of this type has the advantage of being easy to manufacture and of allowing in particular, without very significant change of the manufacturing tool, to manufacture seals of different diameters, since the diameter of the seal depends on the length of the strip in which it is formed. Furthermore, a seal of this type can be easily mounted around or inside the objects for which it must ensure a sealed connection and can be made in a material which does not necessarily have to be deformed notably under radial compression, which makes it possible to choose materials resistant to demanding environmental constraints, for example in terms of temperature, pressure or gradient of these parameters. Particularly, such a seal can be made of a metal of the stainless steel type.

Disclosure For some applications, there is a need to improve the existing open-type seals. Indeed, the opening of the seal, that is to say the junction between the ends of the strip in which it is formed, may have an area of weakness in terms of sealing, despite the fact that the ends in question cooperate together by a sealing arrangement. In addition, depending on the material in which it is formed, the seal may have a spring effect, that is to say the strip in which it is formed may tend to unwind which, in some applications, can complicate the handling, the storage and the mounting.

The disclosure aims at least substantially at overcoming the aforementioned drawbacks.

Thus, the disclosure relates to a seal comprising a first and a second coaxial sleeve disposed around each other while being retained relative to each other, each sleeve being formed by a strip wound on itself whose ends are configured to cooperate together via a sealing arrangement allowing a reduction in the diameter of the sleeve, the sealing arrangements of the two sleeves being angularly offset.

Due to the angular offset of the sealing arrangements of the two sleeves, the sealing arrangement of each sleeve is “bridged” by the other sleeve. Thus, the sealing arrangement of each sleeve is radially covered, either on the external side or on the internal side, by the strip in which the other sleeve is formed. In addition, the sleeves are retained relative to each other, which means that they maintain each other. In other words, the presence of each sleeve tends to oppose the fact that the other sleeve tends to unwind or that it does not keep its desired shape.

However, the seal retains the advantage of the open-type seals in that it is simple to manufacture for different diameters by adjusting the length of the strips in which the two sleeves are formed and in that it achieves its sealing function by a reduction of its diameter bringing the respective ends of the two sleeves closer to each other.

Optionally, the two sleeves are formed in different materials, the strip forming the first sleeve being optionally formed in a mica-based material and the strip forming the second sleeve being optionally metallic.

Optionally, the strip forming at least one of the first and second sleeves naturally tends to unwind and is maintained wound by the other sleeve.

Optionally, the sealing arrangement of at least one of the first and second sleeves comprises a male/female engagement conformation.

Optionally, at least one of the first and second sleeves has at least one squeezing lug, under which one edge of the other sleeve is squeezed.

The present disclosure also relates to a clamping device comprising a collar which has a belt able to be clamped by reduction of its diameter, and a seal according to the present disclosure, wherein the seal is disposed inside the belt while being retained axially relative to the collar and while being configured to arrange an annular space allowing the insertion of an annular object between the seal and the belt.

Thus, this clamping device makes it possible to use a seal operating as an open-type seal pre-mounted in a collar. When the seal is in place in the collar, the annular space allows the insertion of an annular object such as the end of a tube between the belt and the seal. Thus, the clamping device is pre-mounted on this annular object, which can receive another annular object, particularly an internal tube which will be fitted into this assembly, particularly by being fitted into the seal so that this seal is located between the two objects fitted into each other to ensure their sealed connection once the collar is clamped around the fitting thus made.

Optionally, one of the elements comprising the collar and the seal comprises at least one spacer saving the annular space between the seal and the belt, the spacer optionally comprising a spacer lug carried by the seal, protruding radially outwardly.

Optionally, the device comprises an angular seal key configured to determine an angular position of the seal relative to the collar.

Optionally, one of the elements formed by the belt and the seal has a wedge edge and the other element has a wedge protrusion able to cooperate with the wedge edge to retain the seal with respect to a movement relative to the collar.

Optionally, the seal has a front edge provided with at least one abutment configured to cooperate with the front edge of the belt to retain the seal with respect to a movement in at least one direction relative to the belt, the abutment optionally comprising a lug straightened outwardly.

Optionally, the belt has a window whose edge forms a wedge edge, and the seal has a retaining lug projecting in this window.

Optionally, the collar has clamping lugs, raised radially relative to the belt and able to be moved relative to each other to clamp the collar.

The present disclosure also relates to a tube clamping assembly, comprising a clamping device according to the present disclosure and a tube whose end is able to be inserted between the seal and the belt.

Optionally, the assembly comprises a tube position key determining an angular position of the tube relative to at least one of the elements comprising the seal and the collar.

Optionally, the seal has a tube position key lug which protrudes radially outwardly from the seal and which is configured to be engaged in a slot formed at the end of the tube.

Optionally, the seal comprises an anti-extraction lug, configured to cooperate with a window of the tube to oppose the extraction of the seal from the tube.

The description will be well understood and its object will appear better upon reading the following detailed description of one embodiment and its variants, represented by way of non-limiting examples.

### BRIEF DESCRIPTION OF THE DRAWINGS

FIG. 1 is an exploded perspective view showing a tube clamping assembly comprising a seal according to the present disclosure and a clamping device according to the present disclosure.

FIG. 2A is a perspective view of a clamping device according to the present disclosure, from a first angle of view.

FIG. 2B is a perspective view of the clamping device of FIG. 2A from another angle of view

FIG. 3 shows the clamping device in perspective, the seal being represented separate from the collar.

FIG. 4A shows in perspective one of the sleeves of the seal of the clamping device of the preceding figures.

FIGS. 4B to 4D show a partial axial section of a portion of the seal

FIG. 5 shows in perspective the clamping device according to the present disclosure mounted at the end of an outer tube, before fitting of an inner tube into the outer tube.

FIG. 6 is a view similar to FIG. 1 for a variant.

### DESCRIPTION OF THE EMBODIMENTS

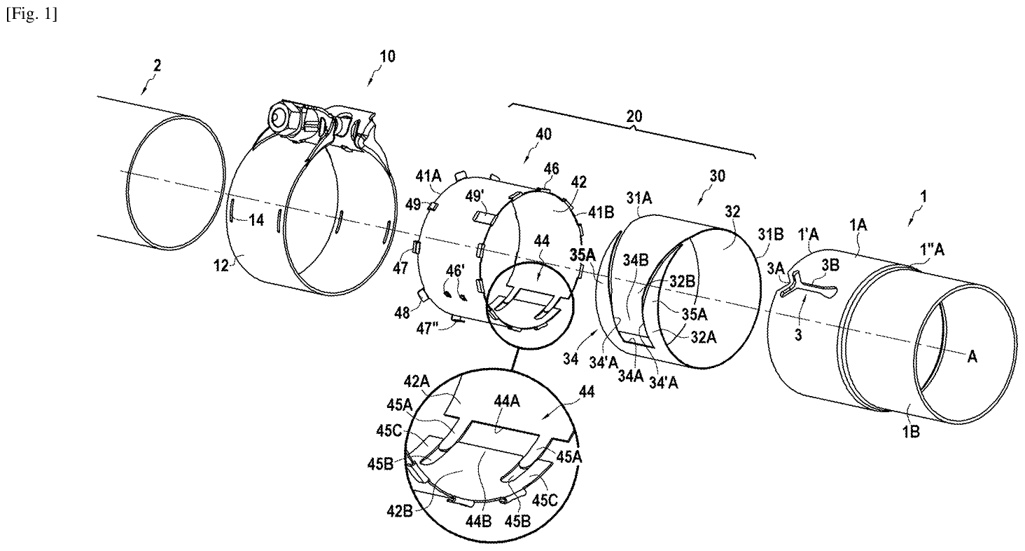

The assembly represented in FIG. 1 comprises a clamping device which itself comprises a collar 10 and a seal 20, which comprises a first sleeve 30 and a second sleeve 40. This assembly also comprises an outer tube 1 and an inner tube 2. The inner tube 2 is configured to be fitted into the outer tube 1 to connect the two tubes. More specifically, the outer tube 2 is fitted into the end 1A of the outer tube 1 around which the clamping collar is placed to clamp the assembly thus made. As will be seen below, in this assembled situation, the seal 20 is itself disposed between the inner and outer tubes. For the fitting, the seal 20 is placed in the end 1A of the tube 1 around which the clamping collar 10 is disposed, and the inner tube 2 is fitted into the seal 20. In this case, the portions of the two tubes 1 and 2 fitted into each other form cylindrical surfaces without bulge. The end 1A of the outer tube 1 is however delimited, on the side opposite to its free end VA, by a shoulder 1″A. The end 1A is thus widened, and the remaining portion 1B of the tube 1 has a similar diameter to that of the tube 2.

Regarding the seal 20, each of the first and second sleeves 30 and 40 is formed by a strip, respectively 32 and 42, which is wound on itself and whose ends are configured to cooperate together via a sealing arrangement.

Thus, the ends 32A and 32B of the strip 32 cooperate together via a sealing arrangement 34 which in this case comprises a male/female engagement. In the example, this sealing arrangement comprises a notch 34A formed at the end 32A and delimited between contact edges 34′A formed in this case by inner edges of lugs 35A remaining on either side of notch 34A.

The sealing arrangement 34 also comprises a tab 34B formed at the end 32B. It can be seen that, over part of the length of the notch, this length being measured circumferentially, the width of this notch (measured parallel to the axis A) varies. More specifically, in the portion of the notch close to the free ends of the lugs 35A, the width of the notch increases in the direction towards to these free ends, that is to say as going away from the bottom of the notch. Similarly, in part of the length of the tab 34B, the width of this tab increases in the direction going away from its free end. Thus, when the tab penetrates deeper into the notch as the diameter of the sleeve 30 decreases upon clamping of the collar, the contact pressure between the edges of the tab and the contact edges 34′A increases so as to achieve a sealed contact. In this case, the terminal portion of the tab and the bottom portion of the notch however have a constant and equal width, which facilitates the advancement of the tab in the notch.

The second sleeve 40 is formed from a strip 42 wound on itself and whose ends, respectively 42A and 42B, cooperate together by a sealing arrangement 44. In this case, this sealing arrangement 44 comprises a male/female engagement conformation. More specifically, the end 42A comprises a notch 44A delimited between two lugs 45A, and the end 42B comprises a tab 44B which, when the diameter of the sleeve 40 decreases, penetrates into the notch 44A. In this case, this tab is delimited laterally by two slots 45B into which the lugs 45A penetrate as the tab 44B penetrates into the notch 44A. These slots 45B are themselves bordered laterally by lugs 45C. In this case, the sealing arrangement forms a sort of baffle considered axially, the contact area between the ends 42A and 42B taking place between the lugs 45C and 45A and the tab 44B.

Of course, other male/female arrangement conformations would be possible. Thus, the sealing arrangement 44 of the sleeve 40 could have the geometry described above for the sealing arrangement 34 of the sleeve 30 and vice versa. Other sealing arrangements can be provided, whether, as in this case, provided directly on the strip 32 or 42, in one piece therewith, or added, for example in a more deformable material. The sealing can also be obtained by a baffle effect without necessarily implementing the contact constraints mentioned above. Conversely, for at least one of the sleeves, the sealing can be linked to the contact constraints mentioned above, particularly within a male/female engagement, these constraints possibly even causing plastic or elastic deformations.

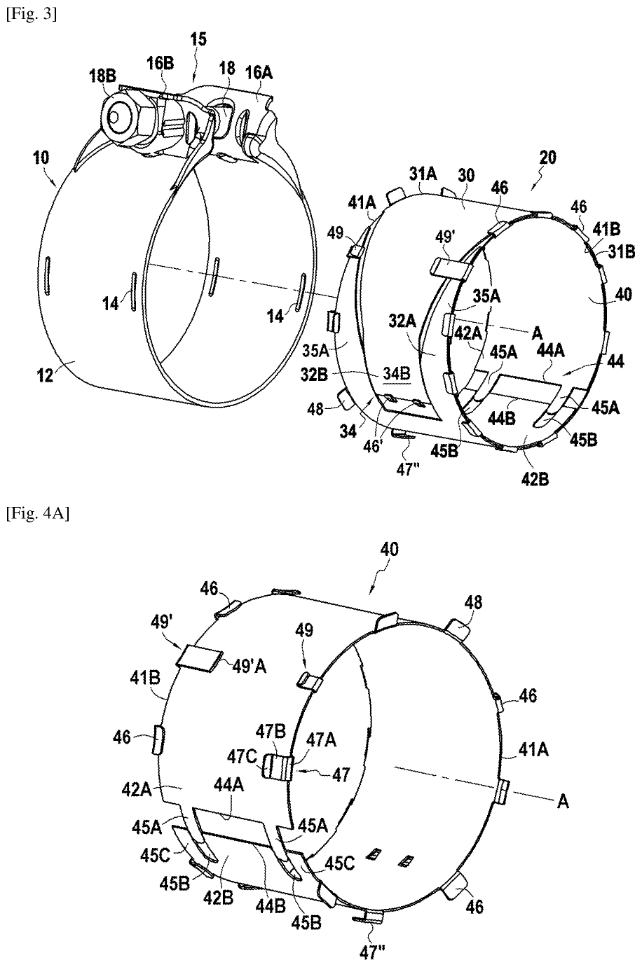

Also referring to FIG. 3, it is understood that, when the sleeves 30 and 40 are assembled around each other to form the seal 20, their respective sealing arrangements 34 and 44 are angularly offset. Thus, as can be seen in FIG. 3, the junction areas between the ends 32A and 32B of the strip in which the sleeve 30 is formed are covered radially by a solid portion of the strip 42 in which the sleeve 40 is formed. Similarly, the junction of the ends 42A and 42B of the strip 42 in which the sleeve 40 is formed is radially covered by a solid portion of the strip 32 in which the sleeve 30 is formed. In this case, the sleeve 30 is disposed around the sleeve 40, so that the sealing arrangement 34 is radially covered on the inner side and that the sealing arrangement 44 is radially covered on the outer side.

Within the meaning of the present disclosure, the elements facing the axis A of the seal (which corresponds to the axis A of the belt of the collar and of the tubes when these elements are assembled) will be referred to as “inner” while the outer elements are those which are opposite to this axis.

Furthermore, the qualifiers “front” and “rear” are understood in relation to the direction of fitting of the tubes. Thus, the end VA of the tube 1 is its front end from which it is fitted onto the tube 2. The front edges 31A and 41A of the sleeves 30 and 40 are those which, when the seal is disposed around the end 1A of the tube 1, are closest to the free end 1′A of this tube, as opposed to the rear edges 31B and 41B of these sleeves.

Whether inner or outer, one of the sleeves can naturally tend to unwind to provide an elastic effect. This can be the case when the sleeve in question is made of metal, as it is for example the case of the second sleeve 40, and can also be the case of a sleeve made in a mica-based material, as it is for example the case of the sleeve 30. However, the fact that the two sleeves are retained relative to each other limits this tendency. Indeed, the first sleeve 30, in particular due to the bridging it operates in the region of the junction between the ends 42A and 42B of the second sleeve 40, tends to oppose the remoteness of these ends 42A and 42B and therefore the unwinding of the strip 42 in which this second sleeve 40 is formed. Conversely, the second sleeve 40, in particular because of the bridging it operates in the region of the junction between the ends 32A and 32B of the first sleeve 30, tends to oppose the remoteness of these ends 32A and 32B and therefore the unwinding of the strip 32 in which this first sleeve 30 is formed.

In this case, as will be seen below, the two sleeves can be retained relative to each other by squeezing. Even if the two sleeves each have a certain elasticity giving them a tendency to unwind, the squeezing constraints (or, generally, the constraints due to the fact that they are retained relative to each other) may be sufficient, by bridging the junction of the ends of each sleeve by the other sleeve, to oppose this unwinding. The squeezing, which can be made in the form of a pinching, has the advantage of achieving the desired retention while allowing slight movements of the two sleeves relative to each other, along their circumferential directions, in order to allow the approximations of the ends of the strips 32 and 42 allowing the reduction of the diameter of the seal under the effect of the clamping of the collar.

In this case, as indicated above, the two sleeves are retained relative to each other by squeezing. Thus, at least one of the first and second sleeves 30 and 40 has at least one squeezing lug 46, under which one edge of the other sleeve, particularly one edge perpendicular to the axis A of the sleeve, is squeezed. In this case, the second sleeve 40 has squeezing lugs 46 under which the edges of the first sleeve 30 are squeezed. In this case, the squeezing lugs 46 are provided on the front 41A and rear 41B edges of the sleeve 40, so as to be able to squeeze the front and rear edges 31A and 31B of the sleeve 30. In this case, insofar as the sleeve 40 is disposed inside the sleeve 30, the squeezing lugs are formed by extensions folded on the side of the outer face of the sleeve 40. For the assembly of the two sleeves, these squeezing lugs can be initially bent radially, then, once the sleeve 30 is disposed around the sleeve 40, be folded against the outer face of this sleeve so as to pinch the edges of the sleeve 30.

In FIGS. 1 and 3, it can be seen that a lug 49′ is longer than the squeezing lugs 46 that have just been described. This lug 49′, in addition to an anti-extraction and tube key function which will be described below, achieves a squeezing function. Because of its length, it squeezes not only the edge of the sleeve 30, but also a lug 35A (the one close to the rear edge of the sleeve 30) and the adjacent edge of the tab 34B of this sleeve. A lug 49, as will be seen below, which achieves both a squeezing function and a tube key function, squeezes the other lug 35A and the edge of the tab 34B which is adjacent to this other lug.

Furthermore, the free end of the tab 34B is itself squeezed under lugs 46′ cut out in the strip 42 and slightly raised.

In this case, the squeezing lugs 46, 49 and 49′ are distributed on each of the front and rear edges of the sleeve 40. It is for example possible to provide between three and fifteen squeezing lugs, for example between four and ten squeezing lugs on either of the front and rear edges. Of course, the number of clamping lugs may depend on the diameter of the sleeve.

It can also be provided that there are more squeezing lugs on one of the edges of the sleeve, for example the rear edge, for example because the other edge would include other lugs or conformations achieving other functions, as will be disclosed below by way of example.

In this case, the squeezing lugs are made in the inner sleeve and folded outwardly, so that the inner periphery of the seal is smooth.

The clamping device according to the present disclosure comprises a clamping collar 10 and the seal that has just been described. As seen in FIGS. 1, 2A, 2B and 3, the collar 10 comprises a belt 12 which is able to be clamped by reduction of its diameter. This belt 12 defines a cylindrical shape coaxial with the sleeves 30 and 40 of the seal 20, when the seal is arranged in the collar and clamped around the tubes.

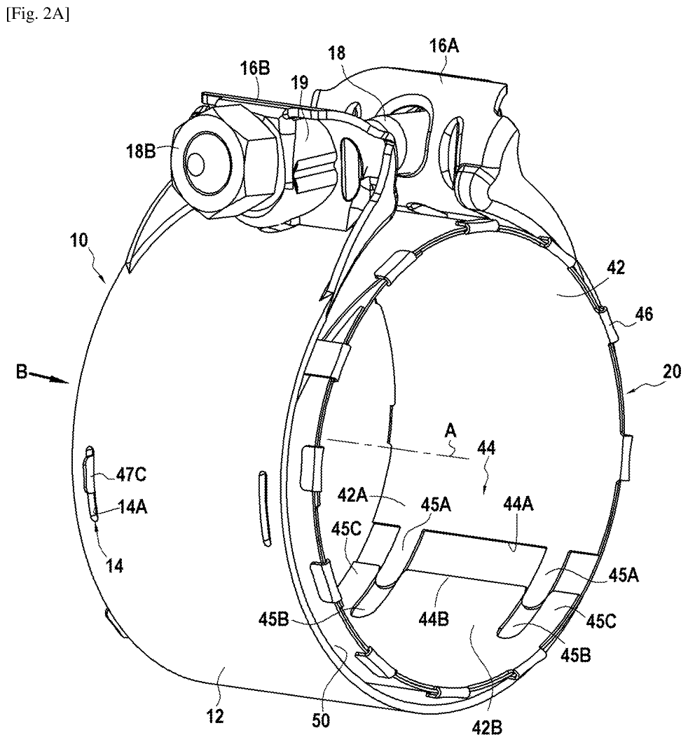

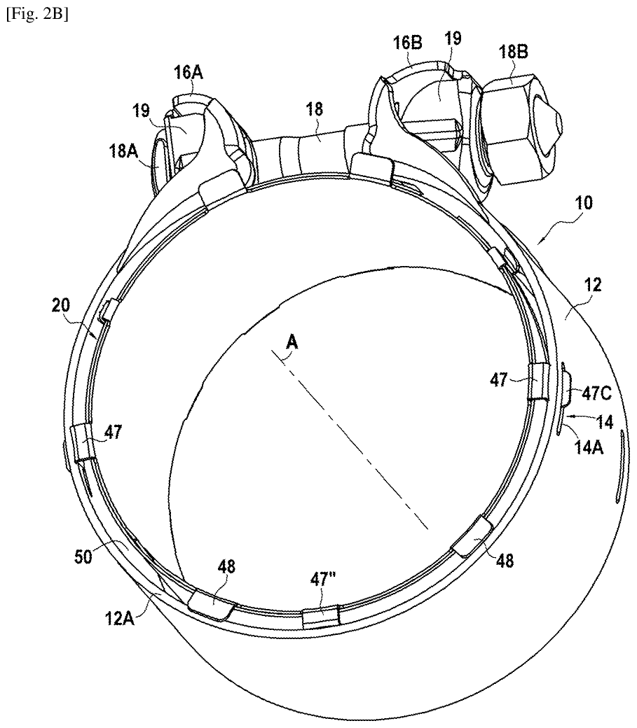

As better seen in FIGS. 2A and 2B, when the seal 20 is disposed in the belt 12 of the collar 10, an annular space 50 is arranged between the outer periphery of the seal 20 (in this case the outer periphery of the sleeve 30) and the inner periphery of the belt 12. As can be understood in FIG. 1, this allows inserting the end 1A of the tube 1 into this annular space.

The annular space 50 can be saved thanks to a spacer which extends between the seal and the belt. In this case, this spacer comprises at least one spacer lug 47 which is carried by the seal 20 and which radially protrudes outwardly. More specifically, in this case, the spacer lug 47 is carried by the sleeve 40 and, like the squeezing lugs 46, 49 and 49′, it is made by an extension of this sleeve folded outwardly.

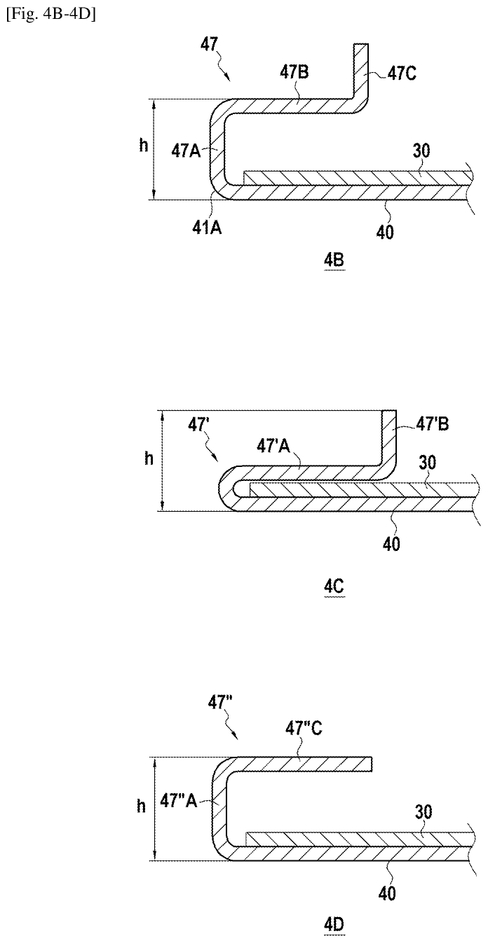

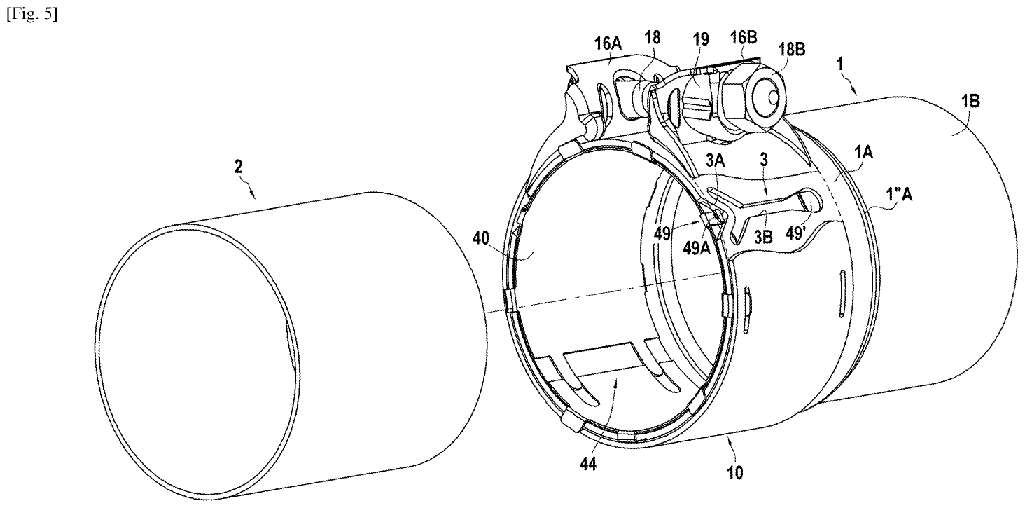

As can be seen in FIGS. 4A to 4D, the spacer lug can have several conformations. FIGS. 4A and 4B represent a spacer lug 47 which, from the front edge 41A of the sleeve 40, is raised radially over a height h along a segment 47A, then folded backward parallel to the sleeve along a segment 47B, then again raised radially along a terminal segment 47C. Considered together, the portion of the sleeve 40 close to its edge 41A, the segment 47A and the segment 47B have an axial U-shaped section. The segment 47B cooperates with the inner periphery of the belt 12 to maintain the abovementioned annular space 50 whose radial height corresponds to the height h. However, the belt 12 of the collar has a window 14 through which the terminal segment 47C protrudes. Thus, the terminal segment 47C of the spacer lug 47 projecting in the window 14 forms a means for wedging the seal 20 relative to the collar, as will be specified below.

In FIG. 4C, the spacer lug 47′ is folded outside the sleeve 40 to form a squeezing lug of the sleeve 30. Thus, it has a folded segment 47′A which forms a squeezing lug pressed on the outer periphery of the sleeve 30. However, the free end 47′B of this lug 47′ is raised radially so as to delimit, relative to the inner periphery of the sleeve 40, a radial height h. Thus, through its raised terminal end 47′B, the lug 47′ cooperates with a solid portion of the belt 12 and can form a spacer. This lug 47′ can replace the lug 49 and achieve both the pinching function already mentioned for the lug 49, the spacer function, and a tube key function, which will be described below.

In FIG. 4D, the lug 47″ is first raised radially then folded backward, and therefore has a first segment 47″A and a second segment 47″C similar to the first and second segments 47A and 47B of the lug 47 of FIG. 4B. Thus, the segment 47″C can cooperate with the inner periphery of the belt to define the abovementioned annular space 50. In this case, the lug 4T does not contribute to the squeezing or pinching of the sleeve 30, but it can contribute to axially wedge it by aligning its front edge 31A on the front edge 41A of the sleeve 40.

Optionally, the device comprises an angular seal key configured to determine an angular position of the seal relative to the collar. In this case, this angular seal key makes use of the lug 47 represented in FIGS. 4A and 4B. Indeed, as indicated above, the raised free end 47C of this lug 47 penetrates into a window 14 of the belt, which angularly wedges the seal relative to the collar. Thus, it can be provided that the seal 20 is oriented angularly relative to the collar so that the sealing arrangements of the ends of the two sleeves 30 and 40 are in a particular position. Regarding, as in the present case, an open-type collar, this allows preventing these arrangements from being located in line with the slot 15 existing between the ends of the collar.

In this case, this angular key is formed by the end of the spacer lug 47. In the same way, it can be provided that such an angular key is formed by the end of a lug having another function, particularly a squeezing lug disposed and extended accordingly, possibly cooperating with a notch of the front edge of the tube 1 to further achieve a tube position key function which will be described later.

Furthermore, this angular key opposes a movement of the seal relative to the collar not only, as disclosed, in the circumferential direction but also in the axial direction, parallel to the axis A. Thus, the edge 14A of the window 14 forms a wedge edge cooperating with the wedge protrusion made by the terminal lug portion 47C to retain the seal 20 with respect to an axial movement relative to the collar 10.

However, in the example represented, the front edge of the seal also has other wedge protrusions. In this case, as can be seen in particular in FIG. 4A, the front edge 41A of the sleeve 40 has tabs 48 radially raised and together delimiting diametrical dimensions greater than the inner diametrical dimensions of the belt 12. This is better visible in FIG. 2B, where it can be seen that the sleeve 40 has a plurality of radially raised lugs 48 which retain the seal 20 by cooperating with the front edge 12A of the belt. In this case, it is therefore the front edge 12A of the belt that serves as wedge edge.

In the example represented, the seal 20 comprises three regularly distributed spacer lugs, namely two lugs 47 of the type represented in FIG. 4B and a lug 4T of the type represented in FIG. 4D, as well as four wedge lugs 48. Of course, different numbers of lugs can be provided. The lugs 48 serve as an abutment opposing the rearward movement of the seal relative to the belt. The wedge protrusions 47C formed by the terminal portions of the lugs 47 oppose for their part an axial movement in both directions.

The seal 20 in this case further comprises a tube position key which, when the clamping device is disposed at the end 1A of the tube 1, determines the angular position of the clamping device relative to the tube. In this case, this tube position key comprises a tube position key lug 49 which protrudes radially outwardly from the seal and which is configured to engage in a slot formed at the end of the tube. Referring to FIG. 1, it can indeed be seen that the end 1A of the tube has a slot 3 which, in this case, comprises a first slot portion 3A forming a notch on the edge VA of the tube and a second portion 3B forming a substantially Y-shaped window, this window having in this case a closed contour. As can be seen in FIG. 5 (in which a portion of the belt 12 covering the slot 3 is torn off to facilitate the understanding), when the collar carrying the seal 20 is fitted on the end 1A of the tube 1, the tube position key lug 49 engages in the notch 3A and therefore makes it possible to angularly wedge the collar relative to the tube. In this case, this tube position key lug 49 is folded backward from the front edge of the sleeve 40. Its free end 49A is itself folded forward by being pinched on itself. As mentioned, the tube position key lug 49 can also, through its portion folded against the sleeve 30, contribute to the blocking of the front edge of the sleeve 30 relative to the sleeve 40. It can also, when its free end 49A is raised radially, contribute to the spacing to keep the seal at a distance from the belt 12 of the collar.

Optionally, the seal 20 also comprises an anti-extraction lug 49′. In this case, this lug 49′ is formed by an extension of the rear edge 41B of the forward folded sleeve 40 outwardly toward the front and whose free end 49′A is slightly raised. It can be seen in FIG. 1 that, when the clamping device is disposed at the end 1A of the tube 1, this lug 49′ protrudes in a portion of the slot 3B of the tube 3. The geometries of this slot portion and of the lug 49′ are such that the lug cooperates with the slot to oppose a forward extraction of the seal relative to the tube. This lug 49′ also achieves a tube position key function, by angularly wedging the seal relative to the tube 1.

In this case, the end 1A of the tube 1 is provided with the slot 3, so that, upon clamping of the collar, the diameter of the end 1A can be reduced by reduction of the width of the slot.

However, this slot is bridged on the internal side by a solid portion of the seal 20. The portion 3B of the slot 3 forms a window with which the anti-extraction lug 49′ cooperates.

The spacer lug which has been described (lugs 47, 47′ and 47″, or even 49) is located on the front edge of the seal, so as not to impede the engagement of the end 1A of the tube 1 between the belt 12 and the seal 20. However, the lug 49′ can also achieve a spacer function keeping the seal at a distance from the belt, provided that it can be erased during the fitting of the end 1A of the tube 1 in the clamping device.

For example, the strip forming the first sleeve 30 is formed in a mica-based material. It is for example a material comprising mica and a silicone-type binder. For example, it may be a material of the type known under the trademark Cogemica Hi-temp® resisting to high temperatures and comprising, by mass, 90% of mica or more and 10% of binder or less. For example, the strip forming the second sleeve 40 can be made of metal, particularly stainless steel. It has been chosen here to place the metal sleeve inside the other sleeve, because it is the metal sleeve which carries, in one piece therewith, the squeezing lugs of the other sleeve, these lugs being folded outwardly. The disposition could be reversed, by placing the metal sleeve outside, while achieving a suitable retention of the two sleeves relative to each other. In this case, the external sleeve can of course carry the seal and/or tube key and spacer lugs.

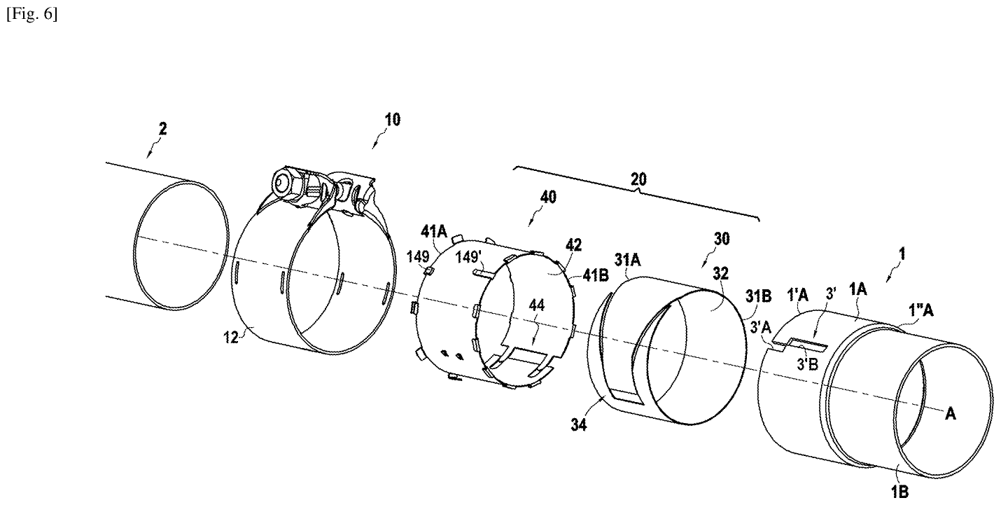

FIG. 6 shows a variant which differs only from the variant that has just been described by the conformation of the slot formed at the end 1A of the tube 1 and, consequently, by the conformation of the anti-extraction and tube position key lugs carried by the seal 20 and, more specifically, by the sleeve 40. Thus, only these elements are described with reference to FIG. 6. it seen in this case that the slot 3′ formed at the end of the tube 1A includes two elementary axial slot segments, particularly a front elementary slot segment 3′A open on the front edge 1′A of the tube, and a closed elementary slot segment 3′B, which forms a window 3′B and which is located at the rear of this slot 3′A and slightly angularly offset relative thereto. The sleeve 40 has for its part a tube position key lug 149 which is folded backwards outside this sleeve 40 and is dimensioned to be able to engage in the open slot portion 3′A of the tube. This sleeve 40 also has an anti-extraction lug 149′ folded forward from the rear edge of this sleeve and slightly angularly offset relative to the lug 149, and whose conformation allows it to engage in the closed slot portion 3′B to oppose a forward extraction of the seal relative to the tube 1.

In the example represented, the collar 10 is of the open type, which means that the ends of the belt 12 are folded radially to form clamping lugs 16A and 16B which are able to be moved relative to each other to clamp the collar. In this case, these clamping lugs cooperate with a clamping rod 18 formed in this case by the shaft of a screw comprising a head 18A which is retained behind the clamping lugs and a nut 18B retained behind the other clamping lug, possibly via spacers 19. In the specific case of the clamping lugs 16A and 16B, the rear of a clamping lug is the side of this lug which is opposite to the other clamping lug. A slot 15 of the collar is thus arranged between the clamping lugs 16A and 16B. The angular positioning of the seal 20 relative to the collar allows preventing the ends of the strips in which the sleeves are formed from being located in line with this slot.

Finally, it is noted that the collar has several series of windows 14 disposed symmetrically relative to a median radial plane of the collar perpendicular to its axis A. This makes it possible to ensure that the collar can be indifferently disposed in either direction relative to this median radial plane (that is to say its rear edge takes the place of its front edge and vice versa) while allowing correct positioning of the seal in the collar.

1. A seal comprising a first and a second coaxial sleeve disposed one around the other while being retained relative to each other, each sleeve being formed by a strip wound on itself whose ends are configured to cooperate together via a sealing arrangement allowing a reduction in the diameter of the sleeve, the sealing arrangements of the two sleeves being angularly offset, at least one of the first and second sleeves has at least one squeezing lug, under which one edge on the other one of the first and second sleeves is squeezed.

2. The seal as claimed in claim 1, wherein the first and second sleeves are formed in different materials.

3. The seal as claimed in claim 1, wherein the strip forming the first sleeve is formed in a mica-based material and the strip forming the second sleeve is in metal.

4. The seal as claimed in claim 1, wherein the strip forming at least one of the first and second sleeves naturally tends to unwind and is maintained wound by the other sleeve.

5. The seal as claimed in claim 1, wherein the sealing arrangement of at least one of the first and second sleeves comprises a male/female engagement configuration.

6. A clamping device comprising a collar comprising a belt able to be clamped by reduction of a diameter thereof, and a seal disposed inside the belt while being retained axially relative to the collar, the seal comprising a first and a second coaxial sleeve disposed one around the other while being retained relative to each other, each sleeve being formed by a strip wound on itself whose ends are configured to cooperate together via a sealing arrangement allowing a reduction in the diameter of the sleeve, the sealing arrangements of the two sleeves being angularly offset and the clamping device being configured to arrange an annular space allowing the insertion of an annular object between the seal and the belt.

7. The clamping device as claimed in claim 6, wherein one of the elements comprising the collar and the seal comprises at least one spacer saving the annular space between the seal and the belt.

8. The clamping device as claimed in claim 7, wherein the spacer comprises a spacer lug carried by the seal, protruding radially outwardly.

9. The clamping device as claimed in claim 6, comprising an angular seal key configured to determine an angular position of the seal relative to the collar.

10. The clamping device as claimed in claim 6, wherein one of the elements comprising the belt and the seal has a wedge edge and the other one of the elements comprising the belt and the seal has a wedge protrusion able to act with the wedge edge to retain the seal with respect to a movement relative to the collar.

11. The clamping device as claimed in claim 6, wherein the seal has a front edge provided with at least one abutment configured to cooperate with the front edge of the belt to retain the seal with respect to a movement in at least one direction relative to the belt.

12. The clamping device as claimed in claim 11, wherein the abutment comprises a lug raised outwardly.

13. The clamping device as claimed in claim 6, wherein the belt has a window whose edge forms a wedge edge, and the seal has a retaining lug projecting in said window.

14. The clamping device as claimed in claim 6, wherein the collar comprises clamping lugs, raised radially relative to the belt and able to be moved relative to each other to clamp the collar.

15. A tube clamping assembly, comprising a collar, a seal and a tube, the collar comprising a belt able to be clamped by reduction of a diameter thereof, the seal being disposed inside the belt while being retained axially relative to the collar, the tube comprising an end able to be inserted in an annular space arranged between the seal and the belt.

16. The tube clamping assembly as claimed in claim 15, wherein the seal comprises a first and a second coaxial sleeve disposed one around the other while being retained relative to each other, each sleeve being formed by a strip wound on itself whose ends are configured to cooperate together via a sealing arrangement allowing a reduction in the diameter of the sleeve, the sealing arrangements of the two sleeves being angularly offset.

17. The tube clamping assembly as claimed in claim 15, wherein one of the elements comprising the collar and the seal comprises at least one spacer saving the annular space between the seal and the belt.

18. The tube clamping assembly as claimed in claim 15, comprising a tube position key determining an angular position of the tube relative to at least one of the elements comprising the seal and the collar.

19. The tube clamping assembly as claimed in claim 15, wherein the seal has a tube position key lug which protrudes radially outwardly from the seal and which is configured to be engaged in a slot formed at the end of the tube.

20. The tube clamping assembly as claimed in claim 15, wherein the seal comprises an anti-extraction lug, configured to cooperate with a window of the tube to oppose the extraction of the seal from the tube.
